(19) United States
(12) Patent Application Publication
(10) Pub. No.: US 2024/0276584 A1
(43) Pub. Date: Aug. 15, 2024

(54) APPLYING A UNIFIED TRANSMISSION CONFIGURATION INDICATOR (TCI) STATE TO A DOWNLINK REFERENCE SIGNAL

(71) Applicant: QUALCOMM INCORPORATED, San Diego, CA (US)

(72) Inventors: Fang Yuan, Beijing (CN); Yan Zhou, San Diego, CA (US); Tao Luo, San Diego, CA (US)

(21) Appl. No.: 18/681,699

(22) PCT Filed: Sep. 30, 2021
(86) PCT No.: PCT/CN2021/122047

§ 371 Date: Feb. 6, 2024

(51) Int. Cl. H04W 76/20; H04L 5/00; H04W 72/1273; H04W 72/232

(52) U.S. Cl. CPC H04W 76/20; H04L 5/0051; H04W 72/1273; H04W 72/232

(57) ABSTRACT

This disclosure provides systems, methods and apparatus for applying a unified transmission configuration indicator (TCI) state to a downlink reference signal in accordance with a rule or procedure that is mutually known between a user equipment (UE) and one or more components of a base station (BS). In one aspect, the UE and one or more components of the BS may support a unified TCI state associated with a transmission over a downlink data channel and a transmission over a downlink control channel. The UE and one or more components of the BS may apply the unified TCI state to the downlink reference signal (which may be associated with beam selection for the downlink reference signal) in accordance with a satisfaction of a condition associated with the downlink reference signal. Such a condition may be associated with one or more parameters or configurations associated with the downlink reference signal.

### CROSS REFERENCE

The present Application is a 371 national stage filing of International PCT Application No. PCT/CN2021/122047 by Yuan et al. entitled “APPLYING A UNIFIED TRANSMISSION CONFIGURATION INDICATOR (TCI) STATE TO A DOWNLINK REFERENCE SIGNAL,” filed Sep. 30, 2021, which is assigned to the assignee hereof, and which is expressly incorporated by reference in its entirety herein.

### TECHNICAL FIELD

This disclosure relates to wireless communications, including applying a unified transmission configuration indicator (TCI) state to a downlink reference signal.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications at a user equipment (UE). The method may include receiving a first control signal indicating a unified transmission configuration indicator (TCI) state, where the unified TCI state is associated with downlink data channel reception and downlink control channel reception, and receiving a downlink reference signal in accordance with the unified TCI state, and associated with satisfaction of a condition.

Another innovative aspect of the subject matter described in this disclosure can be implemented in an apparatus for wireless communications at a UE. The apparatus may include a first interface, a second interface, and a processing system. The first interface may be configured to obtain a first control signal indicating a unified TCI state, where the unified TCI state is associated with downlink data channel reception and downlink control channel reception, and to obtain a downlink reference signal in accordance with the unified TCI state, and associated with satisfaction of a condition.

Another innovative aspect of the subject matter described in this disclosure can be implemented in an apparatus for wireless communications at a UE. The apparatus may include a processor, memory coupled with the processor, and instructions stored in the memory. The instructions may be executable by the processor to cause the apparatus to receive a first control signal indicating a unified TCI state, where the unified TCI state is associated with downlink data channel reception and downlink control channel reception, and receive a downlink reference signal in accordance with the unified TCI state, and associated with satisfaction of a condition.

Another innovative aspect of the subject matter described in this disclosure can be implemented in another apparatus for wireless communications at a UE. The apparatus may include means for receiving a first control signal indicating a unified TCI state, where the unified TCI state is associated with downlink data channel reception and downlink control channel reception, and means for receiving a downlink reference signal in accordance with the unified TCI state, and associated with satisfaction of a condition.

Another innovative aspect of the subject matter described in this disclosure can be implemented in a non-transitory computer-readable medium storing code for wireless communications at a UE. The code may include instructions executable by a processor to receive a first control signal indicating a unified TCI state, where the unified TCI state is associated with downlink data channel reception and downlink control channel reception, and receive a downlink reference signal in accordance with the unified TCI state, and associated with satisfaction of a condition.

Some implementations of the method, apparatuses, and non-transitory computer-readable medium described herein may further include operations, features, means, or instructions for receiving a second control signal indicating a repetition status of the downlink reference signal, where the repetition status satisfies the condition.

Some implementations of the method, apparatuses, and non-transitory computer-readable medium described herein may further include operations, features, means, or instructions for receiving a second control signal indicating a triggering offset associated with the downlink reference signal, where the triggering offset satisfies the condition.

Some implementations of the method, apparatuses, and non-transitory computer-readable medium described herein may further include operations, features, means, or instructions for receiving a second control signal indicating a type of the downlink reference signal, where the condition may be satisfied based on the type of the downlink reference signal.

One innovative aspect of the subject matter described in this disclosure can be implemented in a method for wireless communications at a network entity. The method may include transmitting, to a UE, a first control signal indicating a unified TCI state, where the unified TCI state is associated with downlink data channel transmission and downlink control channel transmission, and transmitting, to the UE, a downlink reference signal in accordance with the unified TCI state, and associated with satisfaction of a condition.

Another innovative aspect of the subject matter described in this disclosure can be implemented in an apparatus for wireless communications at a network entity. The apparatus may include a first interface, a second interface, and a processing system. The first interface may be configured to output, to a UE, a first control signal indicating a unified TCI state, where the unified TCI state is associated with downlink data channel transmission and downlink control channel transmission, and to output, to the UE, a downlink reference signal in accordance with the unified TCI state, and associated with satisfaction of a condition.

Another innovative aspect of the subject matter described in this disclosure can be implemented in another apparatus for wireless communications at a network entity. The apparatus may include a processor, memory coupled with the processor, and instructions stored in the memory. The instructions may be executable by the processor to cause the apparatus to transmit, to a UE, a first control signal indicating a unified TCI state, where the unified TCI state is associated with downlink data channel transmission and downlink control channel transmission, and transmit, to the UE, a downlink reference signal in accordance with the unified TCI state, and associated with satisfaction of a condition.

Another innovative aspect of the subject matter described in this disclosure can be implemented in another apparatus for wireless communications at a network entity. The apparatus may include means for transmitting, to a UE, a first control signal indicating a unified TCI state, where the unified TCI state is associated with downlink data channel transmission and downlink control channel transmission, and means for transmitting, to the UE, a downlink reference signal in accordance with the unified TCI state, and associated with satisfaction of a condition.

Another innovative aspect of the subject matter described in this disclosure can be implemented in a non-transitory computer-readable medium storing code for wireless communications at a network entity. The code may include instructions executable by a processor to transmit, to a UE, a first control signal indicating a unified TCI state, where the unified TCI state is associated with downlink data channel transmission and downlink control channel transmission, and transmit, to the UE, a downlink reference signal in accordance with the unified TCI state, and associated with satisfaction of a condition.

Some implementations of the method, apparatuses, and non-transitory computer-readable medium described herein may further include operations, features, means, or instructions for transmitting a second control signal indicating a repetition status of the downlink reference signal, where the repetition status satisfies the condition.

Some implementations of the method, apparatuses, and non-transitory computer-readable medium described herein may further include operations, features, means, or instructions for transmitting a second control signal indicating a triggering offset associated with the downlink reference signal, where the triggering offset satisfies the condition.

Some implementations of the method, apparatuses, and non-transitory computer-readable medium described herein may further include operations, features, means, or instructions for transmitting a second control signal indicating a type of the downlink reference signal, where the condition may be satisfied based on the type of the downlink reference signal.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates an example wireless communications system that supports applying a unified transmission configuration indicator (TCI) state to a downlink reference signal.

FIG. 2 illustrates an example signaling diagram that supports applying a unified TCI state to a downlink reference signal.

FIG. 3 illustrates an example process flow that supports applying a unified TCI state to a downlink reference signal.

FIGS. 4 and 5 show block diagrams of example devices that support applying a unified TCI state to a downlink reference signal.

FIGS. 6 and 7 show flowcharts illustrating example methods that support applying a unified TCI state to a downlink reference signal.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In some systems, a user equipment (UE) and a network entity (such as one or more components of a base station (BS), which may be co-located, geographically distributed, or virtually distributed) may communicate with each other using directional communication. For example, the UE may transmit to, or receive from, the network entity using a first directional beam that focuses signaling toward the network entity and the network entity may transmit to, or receive from, the UE using a second directional beam that focuses signaling toward the UE. A directional beam may be associated with a transmission configuration indicator (TCI) state and, in some systems, the network entity may configure or activate a TCI state that is common to multiple channel types or associated with multiple link directions. Such a TCI state that is common to multiple channel types or associated with multiple link directions may be referred to herein as a unified TCI state or a common TCI state. For example, the network entity may configure or activate a unified TCI state that is common to both a physical downlink shared channel (PDSCH) and a physical downlink control channel (PDCCH) or that is associated with both uplink communication and downlink communication, or any combination thereof, and the UE and the network entity may use directional beams for transmitting or receiving any such signaling that are associated with the unified TCI state. In some systems, the UE may receive a downlink reference signal in accordance with a unified TCI state that is common to both a PDSCH and a PDCCH. To avoid increased configuration overhead or complexity at the UE it may be desirable to consider one or more conditions associated with the applicability of the unified TCI state to the downlink reference signal.

In some implementations of the present disclosure, the network entity may configure or activate a unified TCI state that the UE may use for both PDSCH reception and PDCCH reception. The UE and the network entity may selectively use the unified TCI state for a downlink reference signal in accordance with whether the downlink reference signal satisfies one or more conditions. For example, the UE and the network entity may each select a directional beam for the downlink reference signal (for receiving or transmitting the downlink reference signal, respectively) in accordance with the unified TCI state as a result of one or more parameters of the downlink reference signal satisfying the one or more conditions. In some implementations, the UE and the network entity may select directional beams for the downlink reference signal in accordance with the unified TCI state in accordance with the downlink reference signal being associated with a repetition parameter of “OFF.” Additionally, or alternatively, the UE and the network entity may select directional beams for the downlink reference signal in accordance with the unified TCI state in accordance with the downlink reference signal having a triggering offset less than a configured beamSwitchTiming parameter. Other conditions of the downlink reference signal that may be associated with selection of directional beams for the downlink reference signal in accordance with the unified TCI state include the downlink reference signal being a specific type, whether another TCT state is configured for the downlink reference signal, whether the PDSCH or PDCCH for which the unified TCI state applies overlap in time with the downlink reference signal, or any combination thereof.

Particular implementations of the subject matter described in this disclosure can be implemented to realize one or more of the following potential advantages. For example, as a result of using a unified TCI state that is common for a PDSCH and a PDCCH for communication of a downlink reference signal in accordance with one or more conditions, the UE and the network entity may more seamlessly and efficiently support directional communication of the downlink reference signal while also avoiding increased configuration overhead or complexity at the UE. As such, the UE and the network entity may experience lower configuration overhead, lower latency, greater spectral efficiency, higher data rates, and greater reliability, among other benefits.

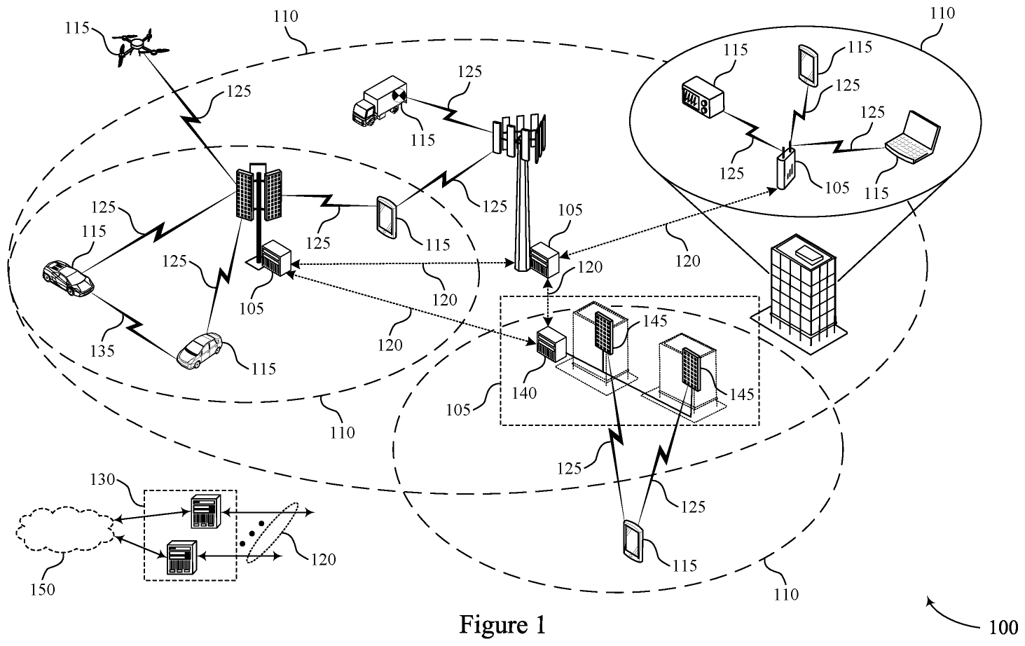

FIG. 1 illustrates an example wireless communications system 100 that supports applying a unified TCI state to a downlink reference signal. The wireless communications system 100 may include one or more base stations (BSs) 105, one or more UEs 115, and a core network 130. In some implementations, the wireless communications system 100 may be a Long Term Evolution (LTE) network, an LTE-Advanced (LTE-A) network, an LTE-A Pro network, or a New Radio (NR) network. In some implementations, the wireless communications system 100 may support enhanced broadband communications, ultra-reliable (for example, mission critical) communications, low latency communications, communications with low-cost and low-complexity devices, or any combination thereof.

The BSs 105 may be dispersed throughout a geographic area to form the wireless communications system 100 and may be devices in different forms or having different capabilities. The BSs 105 and the UEs 115 may wirelessly communicate via one or more communication links 125. Each BS 105 may provide a coverage area 110 over which the UEs 115 and the BS 105 may establish one or more communication links 125. The coverage area 110 may be an example of a geographic area over which a BS 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the BSs 105, or network equipment (for example, core network nodes, relay devices, integrated access and backhaul (IAB) nodes, or other network equipment), as shown in FIG. 1.

The BSs 105 may communicate with the core network 130, or with one another, or both. For example, the BSs 105 may interface with the core network 130 through one or more backhaul links 120 (for example, via an S1, N2, N3, or another interface). The BSs 105 may communicate with one another over the backhaul links 120 (for example, via an X2, Xn, or another interface) either directly (for example, directly between BSs 105), or indirectly (for example, via core network 130), or both. In some implementations, the backhaul links 120 may be or include one or more wireless links.

One or more of the BSs 105 described herein may include or may be referred to by a person having ordinary skill in the art as a base transceiver station, a radio BS, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other implementations.

The UEs 115 described herein may be able to communicate with various types of devices, such as other UEs 115 that may sometimes act as relays as well as the BSs 105 and the network equipment including macro eNBs or gNBs, small cell eNBs or gNBs, or relay BSs, among other implementations, as shown in FIG. 1.

The UEs 115 and the BSs 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation (CA) or multi-carrier operation. A UE 115 may be configured with multiple downlink component carriers and one or more uplink component carriers according to a CA configuration. CA may be used with both frequency division duplexing (FDD) and time division duplexing (TDD) component carriers.

In some implementations (for example, in a CA configuration), a carrier also may have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (for example, of the same or a different radio access technology).

The communication links 125 shown in the wireless communications system 100 may include uplink transmissions from a UE 115 to a BS 105, or downlink transmissions from a BS 105 to a UE 115. Carriers may carry downlink or uplink communications (for example, in an FDD mode) or may be configured to carry downlink and uplink communications (for example, in a TDD mode).

A carrier may be associated with a particular bandwidth of the radio frequency spectrum, and in some implementations the carrier bandwidth may be referred to as a “system bandwidth” of the carrier or the wireless communications system 100. For example, the carrier bandwidth may be one of a number of determined bandwidths for carriers of a particular radio access technology (for example, 1.4, 3, 5, 10, 15, 20, 40, or 80 megahertz (MHz)). Devices of the wireless communications system 100 (for example, the BSs 105, the UEs 115, or both) may have hardware configurations that support communications over a particular carrier bandwidth or may be configurable to support communications over one of a set of carrier bandwidths. In some implementations, the wireless communications system 100 may include BSs 105 or UEs 115 that support simultaneous communications via carriers associated with multiple carrier bandwidths. In some implementations, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (for example, a duration of one modulation symbol) and one subcarrier, where the symbol period and subcarrier spacing are inversely related. The quantity of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

One or more numerologies for a carrier may be supported, where a numerology may include a subcarrier spacing (Δƒ) and a cyclic prefix. A carrier may be divided into one or more BWPs having the same or different numerologies. In some implementations, a UE 115 may be configured with multiple BWPs. In some implementations, a single BWP for a carrier may be active at a given time and communications for the UE 115 may be restricted to one or more active BWPs.

The time intervals for the BSs 105 or the UEs 115 may be expressed in multiples of a basic time unit which may, for example, refer to a sampling period of Tₛ=1/(Δƒₘₐₓ·N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some implementations, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period). In some wireless communications systems 100, a slot may further be divided into multiple mini-slots containing one or more symbols. Excluding the cyclic prefix, each symbol period may contain one or more (for example, N_{ƒ}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some implementations, the TTI duration (for example, the number of symbol periods in a TTI) may be variable. Additionally, or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

Each BS 105 may provide communication coverage via one or more cells, for example a macro cell, a small cell, a hot spot, or other types of cells, or any combination thereof. The term “cell” may refer to a logical communication entity used for communication with a BS 105 (for example, over a carrier) and may be associated with an identifier for distinguishing neighboring cells (for example, a physical cell identifier (PCID), a virtual cell identifier (VCID), or others). In some implementations, a cell also may refer to a geographic coverage area 110 or a portion of a geographic coverage area 110 (for example, a sector) over which the logical communication entity operates. Such cells may range from smaller areas (for example, a structure, a subset of structure) to larger areas depending on various factors such as the capabilities of the BS 105. For example, a cell may be or include a building, a subset of a building, or exterior spaces between or overlapping with geographic coverage areas 110, among other implementations.

A macro cell generally covers a relatively large geographic area (for example, several kilometers in radius) and may allow unrestricted access by the UEs 115 with service subscriptions with the network provider supporting the macro cell. A small cell may be associated with a lower-powered BS 105, as compared with a macro cell, and a small cell may operate in the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A BS 105 may support one or multiple cells and also may support communications over the one or more cells using one or multiple component carriers.

In some implementations, a carrier may support multiple cells, and different cells may be configured according to different protocol types (for example, MTC, narrowband IoT (NB-IoT), enhanced mobile broadband (eMBB)) that may provide access for different types of devices.

In some implementations, a BS 105 may be movable and therefore provide communication coverage for a moving geographic coverage area 110. In some implementations, different geographic coverage areas 110 associated with different technologies may overlap, but the different geographic coverage areas 110 may be supported by the same BS 105. In some other implementations, the overlapping geographic coverage areas 110 associated with different technologies may be supported by different BSs 105. The wireless communications system 100 may include, for example, a heterogeneous network in which different types of the BSs 105 provide coverage for various geographic coverage areas 110 using the same or different radio access technologies.

The wireless communications system 100 may support synchronous or asynchronous operation. For synchronous operation, the BSs 105 may have similar frame timings, and transmissions from different BSs 105 may be approximately aligned in time. For asynchronous operation, the BSs 105 may have different frame timings, and transmissions from different BSs 105 may, in some implementations, not be aligned in time. The techniques described herein may be used for either synchronous or asynchronous operations.

Some UEs 115 may be configured to employ operating modes that reduce power consumption, such as half-duplex communications (for example, a mode that supports one-way communication via transmission or reception, but not transmission and reception simultaneously). In some implementations, half-duplex communications may be performed at a reduced peak rate. Other power conservation techniques for the UEs 115 include entering a power saving deep sleep mode when not engaging in active communications, operating over a limited bandwidth (for example, according to narrow band communications), or a combination of these techniques. For example, some UEs 115 may be configured for operation using a narrow band protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some implementations, a UE 115 also may be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a BS 105. Other UEs 115 in such a group may be outside the geographic coverage area 110 of a BS 105 or be otherwise unable to receive transmissions from a BS 105. In some implementations, groups of the UEs 115 communicating via D2D communications may utilize a one-to-many (1:M) system in which each UE 115 transmits to every other UE 115 in the group. In some implementations, a BS 105 facilitates the scheduling of resources for D2D communications. In some other implementations, D2D communications are carried out between the UEs 115 without the involvement of a BS 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the BSs 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a BS 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or BS 105 may be distributed across various network devices (for example, radio heads and ANCs) or consolidated into a single network device (for example, a BS 105). In various implementations, a BS 105, or an access network entity 140, or a core network 130, or some subcomponent thereof, may be referred to as a network entity.

As described herein, a BS 105 may include components that are located at a single physical location or components located at various physical locations. In examples in which the BS 105 includes components that are located at various physical locations, the various components may each perform various functions such that, collectively, the various components achieve functionality that is similar to a BS 105 that is located at a single physical location. As such, a BS 105 described herein may equivalently refer to a standalone BS 105 or a BS 105 including components that are located at various physical locations or virtualized locations. In some implementations, such a BS 105 including components that are located at various physical locations may be referred to as or may be associated with a disaggregated radio access network (RAN) architecture, such as an Open RAN (O-RAN), Distributed RAN (D-RAN), or Virtualized RAN (VRAN) architecture. In some implementations, such components of a BS 105 may include or refer to one or more of a central unit (CU), a distributed unit (DU), or a radio unit (RU).

The wireless communications system 100 may operate using one or more frequency bands, sometimes in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below: 300 MHz.

The wireless communications system 100 also may operate in a super high frequency (SHF) region using frequency bands from 3 GHz to 30 GHZ, also known as the centimeter band, or in an extremely high frequency (EHF) region of the spectrum (for example, from 30 GHz to 300 GHz), also known as the millimeter band. In some implementations, the wireless communications system 100 may support millimeter wave (mmW) communications between the UEs 115 and the BSs 105, and EHF antennas of the respective devices may be smaller and more closely spaced than UHF antennas. In some implementations, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the BSs 105 and the UEs 115 may employ carrier sensing for collision detection and avoidance. In some implementations, operations in unlicensed bands may be based on or associated with a CA configuration in conjunction with component carriers operating in a licensed band (for example, LAA). Operations in unlicensed spectrum may include downlink transmissions, uplink transmissions, P2P transmissions, or D2D transmissions, among other transmissions.

A BS 105 or a UE 115 may be equipped with multiple antennas, which may be used to employ techniques such as transmit diversity, receive diversity, multiple-input multiple-output (MIMO) communications, or beamforming. The antennas of a BS 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a BS 105 may be located in diverse geographic locations. A BS 105 may have an antenna array with a number of rows and columns of antenna ports that the BS 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The BSs 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which also may be referred to as spatial filtering, directional transmission, or directional reception, is a signal processing technique that may be used at a transmitting device or a receiving device (for example, a BS 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A BS 105 or a UE 115 may use beam sweeping techniques as part of beam forming operations. For example, a BS 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a BS 105 multiple times in different directions. For example, the BS 105 may transmit a signal according to different beamforming weight sets associated with different directions of transmission. Transmissions in different beam directions may be used to identify (for example, by a transmitting device, such as a BS 105, or by a receiving device, such as a UE 115) a beam direction for later transmission or reception by the BS 105.

Some signals, such as data signals associated with a particular receiving device, may be transmitted by a BS 105 in a single beam direction (for example, a direction associated with the receiving device, such as a UE 115). In some implementations, the beam direction associated with transmissions along a single beam direction may be determined based on or in accordance with a signal that was transmitted in one or more beam directions. For example, a UE 115 may receive one or more of the signals transmitted by the BS 105 in different directions and may report to the BS 105 an indication of the signal that the UE 115 received with a highest signal quality or an otherwise acceptable signal quality.

In some implementations, transmissions by a device (for example, by a BS 105 or a UE 115) may be performed using multiple beam directions, and the device may use a combination of digital precoding or radio frequency beamforming to generate a combined beam for transmission (for example, from a BS 105 to a UE 115). The UE 115 may report feedback that indicates precoding weights for one or more beam directions, and the feedback may correspond to a configured number of beams across a system bandwidth or one or more sub-bands. The BS 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a BS 105, a UE 115 may employ similar techniques for transmitting signals multiple times in different directions (for example, for identifying a beam direction for subsequent transmission or reception by the UE 115) or for transmitting a signal in a single direction (for example, for transmitting data to a receiving device).

A receiving device (for example, a UE 115) may try multiple receive configurations (for example, directional listening) when receiving various signals from the BS 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some implementations, a receiving device may use a single receive configuration to receive along a single beam direction (for example, when receiving a data signal). The single receive configuration may be aligned in a beam direction determined based on or in accordance with listening according to different receive configuration directions (for example, a beam direction determined to have a highest signal strength, highest signal-to-noise ratio (SNR), or otherwise acceptable signal quality based on or in accordance with listening according to multiple beam directions).

The UEs 115 and the BSs 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example, using a cyclic redundancy check (CRC)), forward error correction (FEC), and retransmission (for example, automatic repeat request (ARQ)). HARQ may improve throughput at the medium access control (MAC) layer in poor radio conditions (for example, low signal-to-noise conditions). In some implementations, a device may support same-slot HARQ feedback, where the device may provide HARQ feedback in a specific slot for data received in a previous symbol in the slot. In some other implementations, the device may provide HARQ feedback in a subsequent slot, or according to some other time interval.

In some systems, a UE 115 and one or more components of a BS 105 may communicate with each other using one or more directional beams that focus signaling at the receiving device (via constructive interference resulting from different beamforming weights). In some aspects, different directional beams may be associated with different TCI states. For example, a TCI state may provide quasi-colocation (QCL) information for signaling associated with one or more demodulation reference signal (DMRS) ports and the UE 115 and one or more components of the BS 105 may use such QCL information to select suitable or appropriate beams with which to transmit or receive the signaling.

In some systems, such as the wireless communications system 100, a UE 115 and one or more components of a BS 105 may support one or more unified TCI states. For example, one or more components of the BS 105 may configure or activate a unified TCI state that is common for one or more PDSCH transmissions and for one or more PDCCH transmissions and may accordingly perform the one or more PDSCH transmissions and the one or more PDCCH transmissions using a transmit beam associated with the unified TCI state. Likewise, the UE 115 may use a receive beam associated with the unified TCI state to receive the one or more PDSCH transmissions and the one or more PDCCH transmissions. In some systems, the UE 115 and one or more components of the BS 105 may apply the unified TCI state to a downlink reference signal, such as a CSI-RS or a tracking reference signal (TRS). One or more conditions, rules, or restrictions associated with an applicability of a unified TCI state to a downlink reference signal may avoid increased configuration overhead and reduce complexity at the UE. In some systems, however, the UE 115 and one or more components of the BS 105 may lack a configured, defined, or mutually understood rule or configuration according to which unified TCI states may be applicable to downlink reference signals, which may result in such increased configuration overhead and relatively higher complexity at the UE.

In some implementations, the UE 115 and one or more components of the BS 105 may support a mutually understood rule or configuration on whether a unified TCI state is applicable to a downlink reference signal. For example, in accordance with the mutually understood rule or configuration, the UE 115 and one or more components of the BS 105 may apply the unified TCI state to the downlink reference signal in accordance with the downlink reference signal satisfying a condition associated with the downlink reference signal. In some implementations, such a condition of the downlink reference signal may include or refer to a configuration of one or more parameters associated with the downlink reference signal, a type of the downlink reference signal, whether the downlink reference signal is associated with another TCI state (in addition to the unified TCI state), whether the downlink reference signal overlaps with a PDCCH transmission or a PDSCH transmission associated with the unified TCI state, or any combination thereof.

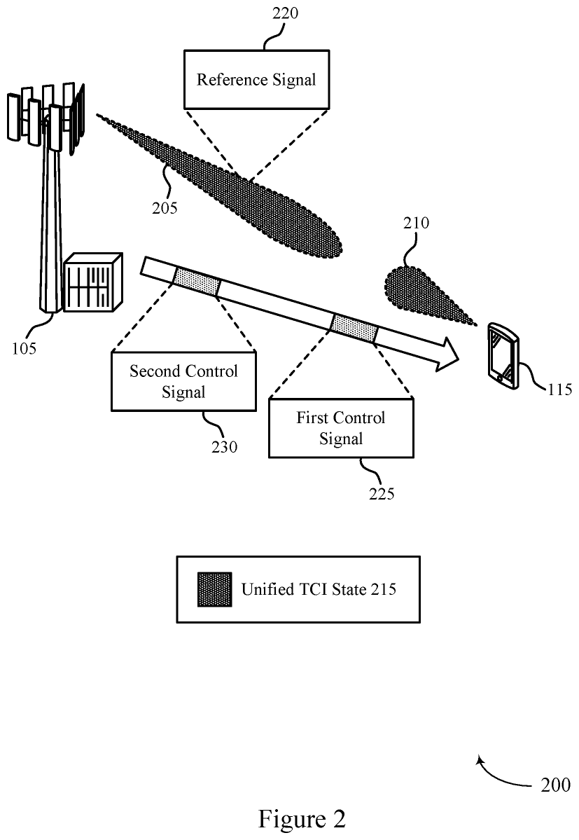

FIG. 2 illustrates an example signaling diagram 200 that supports applying a unified TCI state to a downlink reference signal. The signaling diagram 200 may implement or be implemented to realize one or more aspects of the wireless communications system 100. For example, the signaling diagram 200 illustrates communication between a UE 115 and one or more components of a BS 105. The UE 115 of FIG. 2 may be an example of a UE 115 as illustrated by and described with reference to FIG. 1. The one or more components of a BS 105 of FIG. 2 may be examples of one or more components of a BS 105 as illustrated by and described with reference to FIG. 1 and may include or refer to components that are co-located with each other or that are distributed, such as in a disaggregated RAN or virtualized RAN architecture. In some implementations, the UE 115 and one or more components of the BS 105 may selectively apply (such as apply or refrain from applying) a unified TCI state 215 to a reference signal 220 (a downlink reference signal, such as a CSI-RS or a TRS) in accordance with a satisfaction of one or more conditions associated with the reference signal 220.

For example, the UE 115 and one or more components of the BS 105 may support a unified TCI state framework and some downlink reference signals, such as the reference signal 220, may share a same TCI state (a same unified TCI state 215) as some other communication between the UE 115 and one or more components of the BS 105. In some implementations, for instance, some downlink reference signals may share a same TCI state as which is configured or activated for UE-dedicated reception on a PDSCH and for UE-dedicated reception on a PDCCH on all or a subset of control resource sets (CORESETs) in a component carrier. Such downlink reference signals may include aperiodic CSI-RS resources for CSI acquisition, CSI-RS resources for beam management, or TRSs.

In some aspects, the UE 115 may receive, from one or more components of the BS 105, a first control signal 225 (which may include one or multiple messages) indicating a unified TCI state 215 that is associated with both PDSCH reception and PDCCH reception. The first control signal 225 may include one or more of radio resource control (RRC) signaling configuring the unified TCI state 215, a MAC control element (MAC-CE), which may be sent over a PDSCH, activating the unified TCI state 215, or downlink control information (DCI), which may be sent over a PDCCH, indicating the unified TCI state. Further, although activated and indicated over a PDSCH and a PDCCH, the activated and indicated TCI state may apply to other (such as future) PDSCH and PDCCH transmissions other than the PDSCH and PDCCH transmissions activating and indicating the TCI state.

Whether a specific downlink reference signal, such as the reference signal 220, is able to use a unified TCI state 215 may not be clearly defined or mutually understood between the UE 115 and one or more components of the BS 105. In other words, the UE 115 and one or more components of the BS 105 may apply a unified TCI state 215 to a downlink reference signal in accordance with one or more specified or defined conditions or restrictions, but some current systems may lack any mechanism or configuration associated with such one or more specified or defined conditions or restrictions. To reduce configuration overhead and to reduce complexity at the UE, some systems may clarify such conditions or restrictions associated with an applicability of a unified TCI state 215 to a downlink reference signal. Some systems may further define other relevant CSI-RS time-domain behaviors or restrictions, or both, associated with the applicability of a unified TCI state 215 to a downlink reference signal.

In some implementations, the UE 115 and one or more components of the BS 105 may support or follow a rule or configuration according to which the UE 115 and one or more components of the BS 105 may selectively apply a unified TCI state 215 to a reference signal 220. For example, such a rule or configuration may define or may otherwise be associated with one or more applicability conditions or restrictions of the unified TCI state 215 to the reference signal 220. In other words, the UE 115 and one or more components of the BS 105 may support conditional application or a restriction for the reference signal 220 sharing the same unified TCI state 215 as which is configured and activated for UE-dedicated reception on a PDSCH and for UE-dedicated reception on a PDCCH on all or a subset of CORESETs in a component carrier. In some aspects, the one or more conditions associated with the reference signal 220 may vary in accordance with whether the reference signal 220 is an aperiodic reference signal or a periodical or semi-persistent reference signal. In some implementations, the UE 115 and one or more components of the BS 105 may not apply the unified TCI state 215 to the reference signal 220 if the reference signal 220 is periodical.

In some implementations, the UE 115 and one or more components of the BS 105 may selectively apply the unified TCI state 215 to the reference signal 220 in accordance with whether the reference signal 220 is configured with a higher layer parameter, such as an RRC parameter, “repetition” set as “ON” or “OFF.” For example, the UE 115 and one or more components of the BS 105 may apply the unified TCI state 215 to the reference signal 220 if the reference signal 220 is associated with a “repetition” parameter set as “OFF.” In some aspects, the UE 115 and one or more components of the BS 105 may support such an applicability of the unified TCI state 215 to the reference signal 220 in accordance with the “repetition” parameter being set as “OFF” because the UE 115 may use different reception beams for reception beam improvement (for example, as part of a P3 procedure) if the “repetition” parameter is set as “ON.” In such examples in which the UE 115 and one or more components of the BS 105 selectively apply the unified TCI state 215 to the reference signal 220 in accordance with the setting of the higher layer parameter “repetition,” the reference signal 220 may be an example of an aperiodic CSI-RS, such as an aperiodic CSI-RS for beam management. In some aspects, the UE 115 may receive, from one or more components of the BS 105, an indication of the “repetition” parameter via a second control signal 230, which may refer to or include one or multiple messages. In some other implementations, the UE 115 and one or more components of the BS 105 may not apply the unified TCI state 215 to the reference signal 220 if the reference signal 220 is configured with a “repetition” parameter. In some other implementations, the UE 115 and one or more components of the BS 105 may not apply the unified TCI state 215 to the reference signal 220 if the reference signal 220 is configured with a “trs-Info” parameter.

Additionally, or alternatively, the UE 115 and one or more components of the BS 105 may selectively apply the unified TCI state 215 to the reference signal 220 in accordance with whether a triggering offset associated with the reference signal 220 is less than or greater than a time duration associated with a beam switching capability of the UE 115. For example, the UE 115 and one or more components of the BS 105 may compare the triggering offset associated with the reference signal 220 to a beamSwitchTiming parameter and may selectively apply the unified TCI state 220 to the reference signal 220 in accordance with the comparison. In some implementations, the UE 115 and one or more components of the BS 105 may apply the unified TCI state 215 to the reference signal 220 if the reference signal 220 is associated with a triggering offset that is less than a time duration associated with (such as defined by) the beamSwitchTiming parameter. In some other implementations, the UE 115 and one or more components of the BS 105 may apply the unified TCI state 215 to the reference signal 220 if the reference signal 220 is associated with a triggering offset regardless of a time duration associated with (such as defined by) the beamSwitchTiming parameter.

In some aspects, the UE 115 and one or more components of the BS 105 may support such an applicability of the unified TCI state 215 to the reference signal 220 in accordance with the trigger offset because the UE 115 may use (in accordance with another configuration or rule) a default beam when the triggering offset is smaller or less than the beam switching time of the UE 115. In such examples in which the UE 115 and one or more components of the BS 105 selectively apply the unified TCI state 215 to the reference signal 220 in accordance with the triggering offset associated with the reference signal 220, the reference signal 220 may be an example of an aperiodic CSI-RS. In some aspects, the UE 115 may receive, from one or more components of the BS 105, an indication of the triggering offset or the beamSwitchTiming parameter, or both, via the second control signal 230, which may refer to or include one or multiple messages.

Additionally, or alternatively, the UE 115 and one or more components of the BS 105 may selectively apply the unified TCI state 215 to the reference signal 220 in accordance with a type of the reference signal 220. For example, the UE 115 and one or more components of the BS 105 may selectively apply the unified TCI state to the reference signal 220 in accordance with whether the reference signal 220 is a UE-dedicated reference signal or a cell-specific reference signal or in accordance with whether the reference signal 220 is periodically or semi-persistently scheduled. In some aspects, the UE 115 may receive, from one or more components of the BS 105, an indication of the type of the reference signal 220 via the second control signal 230, which may refer to or include one or multiple messages.

In some implementations, the UE 115 and one or more components of the BS 105 may apply the unified TCI state 215 to the reference signal 220 if the reference signal 220 is a cell-specific reference signal, such as a cell-specific TRS (for the UE 115 in an idle state or mode). In some aspects, the UE 115 and one or more components of the BS 105 may apply the unified TCI state 215 to the reference signal 220 if the reference signal 220 is a cell-specific reference signal because application of the unified TCI state 215 to a cell-specific reference signal may save overhead costs associated with configuring another TCI state for the cell-specific reference signal as compared to an application of the unified TCI state 215 to a UE-dedicated reference signal (as, for cell-specific reference signals, another configuration may otherwise be provided to configure or activate a TCI state for the reference signal 220).

Additionally, or alternatively, the UE 115 and one or more components of the BS 105 may apply the unified TCI state 215 to the reference signal 220 if the reference signal 220 is a periodical or semi-persistent reference signal. For instance, in examples in which the reference signal 220 is a CSI-RS for CSI acquisition or for beam management, the UE 115 and one or more components of the BS 105 may apply the unified TCI state 215 to the reference signal 220 if the reference signal 220 is configured as a periodic or semi-persistent CSI-RS for CSI-acquisition. As such, the UE 115 may use the same unified TCI state 215 for periodic or semi-persistent CSI-RS for CSI-acquisition, which the UE 115 may use to measure or otherwise obtain a channel quality associated with the PDSCH and the PDCCH, as for receiving the actual PDSCH and PDCCH transmissions, which may provide for more complete or accurate CSI acquisition at the UE 115.

Additionally, or alternatively, the UE 115 and one or more components of the BS 105 may apply the unified TCI state 215 to the reference signal 220 in accordance with whether another TCI state is available for the reference signal 220. In other words, the UE 115 and one or more components of the BS 105 may selectively apply the unified TCI state 215 to the reference signal 220 if the unified TCI state is available (such as activated or indicated) and in accordance with whether the reference signal 220 has another TCI state (previously or already) configured by RRC signaling, activated by a MAC-CE, or indicated by DCI.

For example, the UE 115 and one or more components of the BS 105 may apply the unified TCI state 215 to the reference signal 220 if the reference signal 220 lacks an association with another configured or activated TCI state (in addition to the unified TCI state 215). In such examples in which the UE 115 and one or more components of the BS 105 selectively apply the unified TCI state 215 to the reference signal 220 in accordance with whether the reference signal 220 is associated with another TCI state, the UE 115 and one or more components of the BS 105 may apply the unified TCI state 215 to the reference signal 220 in accordance with whether the second control signal 230, which may refer to or include one or multiple messages, indicates that the reference signal 220 lacks an associated with another configured or activated TCI state. Further, in such examples, the UE 115 and one or more components of the BS 105 may use such an available TCI state-based condition for any type of downlink reference signal.

Additionally, or alternatively, the UE 115 and one or more components of the BS 105 may selectively apply the unified TCI state 215 to the reference signal 220 in accordance with whether a default TCI state from another downlink channel (such as a PDSCH or a PDCCH) or reference signal that is linked to the reference signal 220 can be a unified TCI state 215. For example, the UE 115 and one or more components of the BS 105 may apply the unified TCI state 215 to the reference signal 220 if a default TCI state associated with the other downlink channel or reference signal to which the reference signal 220 is linked may be a unified TCI state 215. As such, if the default TCI state associated with the other downlink channel or reference signal is the unified TCI state 215, the UE 115 and one or more components of the BS 105 may apply the unified TCI state to the reference signal 220.

In some aspects, such linking may refer to an overlapping in the time-domain between the reference signal 220 and the other downlink channels or reference signals. In such aspects, the UE 115 may receive, from one or more components of the BS 105, an indication of time domain resources for the other downlink channels or reference signals for which the unified TCI state is configured via the second control signal 230 and the UE 115 and one or more components of the BS 105 may apply the unified TCI state 215 to the reference signal 220 if the reference signal 220 overlaps with at least a subset of the time domain resources.

For example, if the UE 115 receives two channels or reference signals of different QCL assumptions (which may be associated with different TCI states), the UE 115 may apply one prioritized QCL assumption (one prioritized TCI state) to the two channels or reference signals if the two channels or reference signals at least partially overlap in the time domain. For instance, if an aperiodic CSI-RS overlaps (in time) with a scheduled PDSCH transmission, the UE 115 may use a QCL assumption for the aperiodic CSI-RS associated with a TCI state configured, activated, or indicated for the PDSCH transmission. In other words, if there is any other downlink signal with an indicated TCI state in a same one or more symbols as the aperiodic CSI-RS, the UE 115 may apply the QCL assumption of the other downlink signal for receiving the aperiodic CSI-RS. As such, if any other downlink signal has an indicated TCI state and overlaps with the reference signal 220 (which may be an example of an aperiodic CSI-RS), the UE 115 and one or more components of the BS 105 may use the indicated TCI state for the reference signal 220 as well (such as in addition to the any other downlink signal).

Thus, if the indicated TCI state to the any other downlink signal is a unified TCI state, the UE 115 and one or more components of the BS 105 may apply the unified TCI state to the reference signal 220. Such an application of a TCI state in accordance with some time-domain overlapping between signals may be referred to as an available TCI state from a default TCI state rule or procedure and, in some aspects, may be defined for aperiodic CSI-RS. Further, in such examples in which the UE 115 and one or more components of the BS 105 use such an available TCI state from a default TCI state rule or procedure as a condition for applying the unified TCI state 215 to the reference signal 220, the reference signal 220 may be any type of downlink reference signal.

The UE 115 and one or more components of the BS 105 may each select a directional beam for communicating the reference signal 220 in accordance with whether the UE 115 and one or more components of the BS 105 apply the unified TCI state 215 to the reference signal 220. In examples in which the UE 115 and one or more components of the BS 105 apply the unified TCI state 215 to the reference signal 220 (such as in accordance with satisfaction of one or more conditions associated with the reference signal 220), one or more components of the BS 105 may select a transmit beam 205 in accordance with the unified TCI state 215 and the UE 115 may select a receive beam 210 in accordance with the unified TCI state 215. Accordingly, one or more components of the BS 105 may use the transmit beam 205 to transmit the reference signal 220 to the UE 115. Likewise, the UE 115 may use the receive beam 210 to receive the reference signal 220 from one or more components of the BS 105.

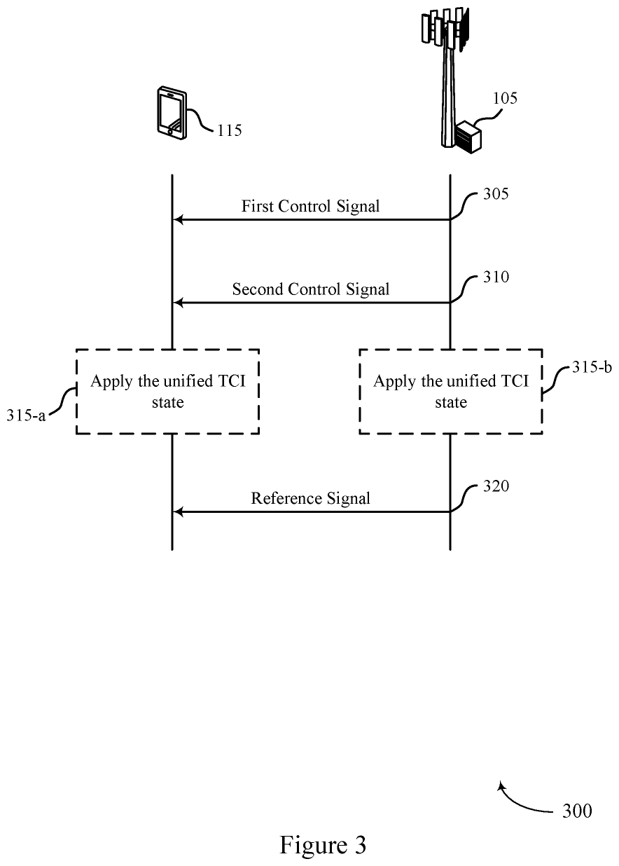

FIG. 3 illustrates an example process flow 300 that supports applying a unified TCI state to a downlink reference signal. The process flow 300 may implement or be implemented to realize one or more aspects of the wireless communications system 100 or the signaling diagram 200. For example, the process flow 300 illustrates communication between a UE 115 and one or more components of a BS 105 . The UE 115 of FIG. 3 may be an example of a UE 115 as illustrated by and described with reference to FIG. 1 or 2. The one or more components of the BS 105 of FIG. 3 may be examples of one or more components of a BS 105 as illustrated by and described with reference to FIG. 1 or 2. In some aspects, the one or more components of the BS 105 may be individually or collectively referred to as a network entity. In some implementations the UE 115 and one or more components of the BS 105 may selectively apply a unified TCI state to a downlink reference signal in accordance with a satisfaction of a condition associated with the downlink reference signal.

In the following description of the process flow 300, the operations may be performed (such as reported or provided) in a different order than the order shown, or the operations performed by the example devices may be performed in different orders or at different times. Some operations also may be omitted from the process flow 300, or other operations may be added to the process flow 300. Further, although some operations or signaling may be shown to occur at different times for discussion purposes, these operations may actually occur at the same time or otherwise concurrently.

At 305, the UE 115 may receive, from one or more components of the BS 105, a first control signal indicating a unified TCI state. In some implementations, the unified TCI state may be associated with PDSCH reception and PDCCH reception. In other words, the UE 115 and one or more components of the BS 105 may use same directional beams for both communication over an associated PDSCH and an associated PDCCH in accordance with the unified TCI state.

At 310, the UE 115 may receive, from one or more components of the BS 105, a second control signal. In some implementations, the second control signal may indicate various parameters or configurations associated with a downlink reference signal and the UE 115 and one or more components of the BS 105 may select, configure, or otherwise determine to apply the unified TCI state to the downlink reference signal if one or more of the various parameters or configurations associated with the downlink reference signal satisfy a condition.

In some implementations, the second control signal may indicate a repetition status of the downlink reference signal. In some of such examples, the repetition status (which one or more components of the BS 105 may convey via a “repetition” parameter) may satisfy the condition by indicating a lack of repetition for the downlink reference signal. In some implementations, the second control signal may indicate a triggering offset associated with the downlink reference signal. In some of such examples, the triggering offset may satisfy the condition by being less than a time duration associated with a beam switching capability of the UE 115 (as configured by a beamSwitchTiming parameter, for example). In some implementations, the second control signal may indicate a type of the downlink reference signal. In some of such examples, the type of the downlink reference signal may satisfy the condition by being a periodic or semi-persistent reference signal for CSI acquisition or by being a cell-specific reference signal.

In some implementations, the second control signal may indicate whether another TCI state is configured or activated for the downlink reference signal. In some of such examples, the condition may be satisfied if the second control signal indicates a lack of an association with another configured or activated TCI state for the downlink reference signal. In some implementations, the second control signal may indicate timing resources for at least one of the PDCCH or the PDSCH to which the unified TCI state applies. In some of such examples, the condition may be satisfied if the downlink reference signal at least partially overlaps with the timing resources associated with at least one of the PDCCH or the PDSCH.

At 315-a, the UE 115 may selectively apply the unified TCI state to the downlink reference signal in accordance with whether the condition associated with the downlink reference signal is satisfied. In some implementations, the UE 115 may apply the unified TCI state to the downlink reference signal in accordance with or as a result of the condition associated with the reference signal being satisfied. Alternatively, the UE 115 may refrain from applying the unified TCI state to the downlink reference signal in accordance with or as a result of the condition associated with the reference signal failing to be satisfied.

At 315-b, one or more components of the BS 105 may selectively apply the unified TCI state to the downlink reference signal in accordance with whether the condition associated with the downlink reference signal is satisfied. In some implementations, one or more components of the BS 105 may apply the unified TCI state to the downlink reference signal in accordance with or as a result of the condition associated with the reference signal being satisfied. Alternatively, one or more components of the BS 105 may refrain from applying the unified TCI state to the downlink reference signal in accordance with or as a result of the condition associated with the reference signal failing to be satisfied.

In some aspects, the UE 115 may selectively apply the unified TCI state to the downlink reference signal at 315-a and one or more components of the BS 105 may selectively apply the unified TCI state to the downlink reference signal at 315-b concurrently or simultaneously. Alternatively, in some other aspects, the UE 115 may selectively apply the unified TCI state to the downlink reference signal before or after one or more components of the BS 105 selectively apply the unified TCI state to the downlink reference signal. For example, one or more components of the BS 105 may apply the unified TCI state to the downlink reference signal during or shortly after configuration of the various parameters or configurations associated with the downlink reference signal (which may occur prior to transmission of the second control signal at 310) and the UE 115 may apply the unified TCI state to the downlink reference signal after receiving the configuration of the various parameters or configurations associated with the downlink reference signal (which may occur after the transmission of the second control signal at 310).

At 320, the UE 115 may receive, from one or more components of the BS 105, the downlink reference signal in accordance with the unified TCI state and in accordance with the satisfaction of the condition associated with the downlink reference signal. For example, the UE 115 may select a receive beam in accordance with the unified TCI state and one or more components of the BS 105 may select a transmit beam in accordance with the unified TCI state and the UE 115 and one or more components of the BS 105 may communicate the downlink reference signal using the selected beams. Alternatively, the UE 115 and one or more components of the BS 105 may refrain from applying the unified TCI state to the downlink reference signal and may select beams with which to communicate the downlink reference signal using some other TCI state or in accordance with some other beamforming procedure or technique (such as a beam sweeping technique). In some aspects, the downlink reference signal may include or be an example of a CSI-RS or a TRS and the UE 115 may transmit a CSI report or a beam management report associated with the receiving of the downlink reference signal.

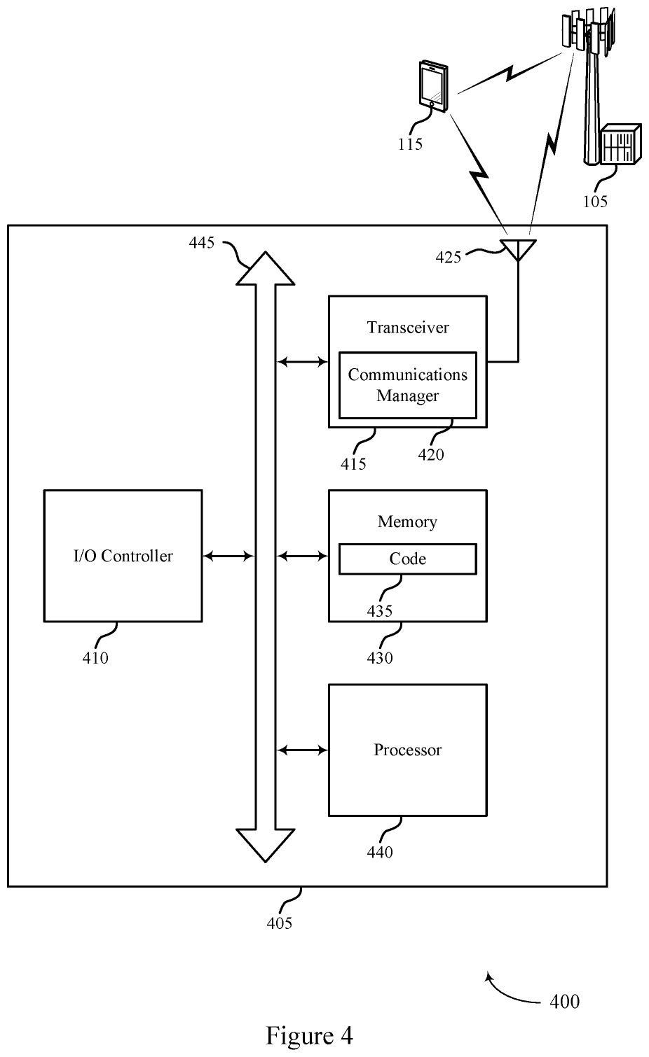

FIG. 4 shows a block diagram 400 of an example device 405 that supports applying a unified TCI state to a downlink reference signal. The device 405 may communicate wirelessly with one or more base stations 105, UEs 115, or any combination thereof. The device 405 may include components for bi-directional voice and data communications including components for transmitting and receiving communications, such as a communications manager 420, an input/output (I/O) controller 410, a transceiver 415, an antenna 425, a memory 430, code 435, and a processor 440. These components may be in electronic communication or otherwise coupled (such as operatively, communicatively, functionally, electronically, electrically) via one or more buses (such as a bus 445).

The I/O controller 410 may manage input and output signals for the device 405. The I/O controller 410 also may manage peripherals not integrated into the device 405. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. Additionally, or alternatively, the I/O controller 410 may represent or interact with a modem, a keyboard, a mouse, a touchscreen, or a similar device. In some implementations, the I/O controller 410 may be implemented as part of a processor or processing system, such as the processor 440. In some implementations, a user may interact with the device 405 via the I/O controller 410 or via hardware components controlled by the I/O controller 410.

In some implementations, the device 405 may include a single antenna 425. However, in some other implementations, the device 405 may have more than one antenna 425, which may be capable of concurrently transmitting or receiving multiple wireless transmissions. The transceiver 415 may communicate bi-directionally, via the one or more antennas 425, wired, or wireless links as described herein. For example, the transceiver 415 may represent a wireless transceiver and may communicate bi-directionally with another wireless transceiver. The transceiver 415 also may include a modem to modulate the packets, to provide the modulated packets to one or more antennas 425 for transmission, and to demodulate packets received from the one or more antennas 425.

In some implementations, the transceiver 415 may include one or more interfaces, such as one or more interfaces coupled with the one or more antennas 425 that are configured to support various receiving or obtaining operations, or one or more interfaces coupled with the one or more antennas 425 that are configured to support various transmitting or outputting operations, or a combination thereof. In some implementations, the transceiver 415 may include or be configured for coupling with one or more processors or memory components that are operable to perform or support operations based on or associated with received or obtained information or signals, or to generate information or other signals for transmission or other outputting, or any combination thereof. In some implementations, the transceiver 415, or the transceiver 415 and the one or more antennas 425, or the transceiver 415 and the one or more antennas 425 and one or more processors or memory components (for example, the processor 440, or the memory 430, or both), may be included in a chip or chip assembly that is installed in the device 405.

The memory 430 may include random access memory (RAM) and read-only memory (ROM). The memory 430 may store computer-readable, computer-executable code 435 including instructions that, when executed by the processor 440, cause the device 405 to perform various functions described herein. The code 435 may be stored in a non-transitory computer-readable medium such as system memory or another type of memory. In some implementations, the code 435 may not be directly executable by the processor 440 but may cause a computer (for example, when compiled and executed) to perform functions described herein. In some implementations, the memory 430 may contain, among other things, a basic I/O system (BIOS) which may control basic hardware or software operation such as the interaction with peripheral components or devices.

The processor 440 may be any one or more suitable processors capable of executing scripts or instructions of one or more software programs stored in the device 405 (such as within the memory 430). In some implementations, the processor 440 may be a component of a processing system. A processing system may generally refer to a system or series of machines or components that receives inputs and processes the inputs to produce a set of outputs (which may be passed to other systems or components of, for example, the device 405). For example, a processing system of the device 405 may refer to a system including the various other components or subcomponents of the device 405, such as the processor 440, or the transceiver 415, or the communications manager 420, or other components or combinations of components of the device 405. The processing system of the device 405 may interface with other components of the device 405, and may process information received from other components (such as inputs or signals) or output information to other components. For example, a chip or modem of the device 405 may include a processing system, a first interface to output information, and a second interface to obtain information. In some implementations, the first interface may refer to an interface between the processing system of the chip or modem and a transmitter, such that the device 405 may transmit information output from the chip or modem. In some implementations, the second interface may refer to an interface between the processing system of the chip or modem and a receiver, such that the device 405 may obtain information or signal inputs, and the information may be passed to the processing system. A person having ordinary skill in the art will readily recognize that the first interface also may obtain information or signal inputs, and the second interface also may output information or signal outputs.

The communications manager 420 may support wireless communication at a UE in accordance with examples as disclosed herein. For example, the communications manager 420 may be configured as or otherwise support a means for receiving a first control signal indicating a unified TCI state, where the unified TCI state is associated with downlink data channel reception and downlink control channel reception. The communications manager 420 may be configured as or otherwise support a means for receiving a downlink reference signal in accordance with the unified TCI state, and associated with satisfaction of a condition.

In some implementations, the communications manager 420 may be configured as or otherwise support a means for receiving a second control signal indicating a repetition status of the downlink reference signal, where the repetition status satisfies the condition. In some implementations, the repetition status satisfies the condition by the repetition status indicating a lack of repetition for the downlink reference signal.

In some implementations, the communications manager 420 may be configured as or otherwise support a means for receiving a second control signal indicating a triggering offset associated with the downlink reference signal, where the triggering offset satisfies the condition. In some implementations, the triggering offset satisfies the condition by the triggering offset being less than a time duration associated with a beam switching capability of the UE.

In some implementations, the communications manager 420 may be configured as or otherwise support a means for receiving a second control signal indicating a type of the downlink reference signal, where the condition is satisfied based on or associated with the type of the downlink reference signal. In some implementations, the type of the downlink reference signal satisfies the condition by the type being a cell-specific reference signal. In some implementations, the type of the downlink reference signal satisfies the condition by the type being a periodic or semi-persistent reference signal that is for channel state information acquisition.

In some implementations, the condition is satisfied based on or associated with whether the downlink reference signal is associated with a configured TCI state. In some implementations, the downlink reference signal lacking an association with the configured TCI state satisfies the condition.

In some implementations, the communications manager 420 may be configured as or otherwise support a means for receiving an indication of timing resources for at least one of a downlink data channel or a downlink control channel associated with the unified TCI state, where the condition is satisfied based on or associated with whether the downlink reference signal at least partially overlaps the timing resources. In some implementations, the downlink reference signal at least partially overlapping in time with at least one of the downlink data channel or the downlink control channel satisfies the condition.

In some implementations, the communications manager 420 may be configured as or otherwise support a means for transmitting a channel state information report or a beam management report associated with the receiving of the downlink reference signal, where the downlink reference signal includes a channel state information reference signal or a tracking reference signal.

In some implementations, the communications manager 420 may be configured to perform various operations (for example, receiving, monitoring, transmitting) using or otherwise in cooperation with the transceiver 415, the one or more antennas 425, or any combination thereof. Although the communications manager 420 is illustrated as a separate component, in some implementations, one or more functions described with reference to the communications manager 420 may be supported by or performed by the processor 440, the memory 430, the code 435, or any combination thereof. For example, the code 435 may include instructions executable by the processor 440 to cause the device 405 to perform various aspects of applying a unified TCI state to a downlink reference signal as described herein, or the processor 440 and the memory 430 may be otherwise configured to perform or support such operations.

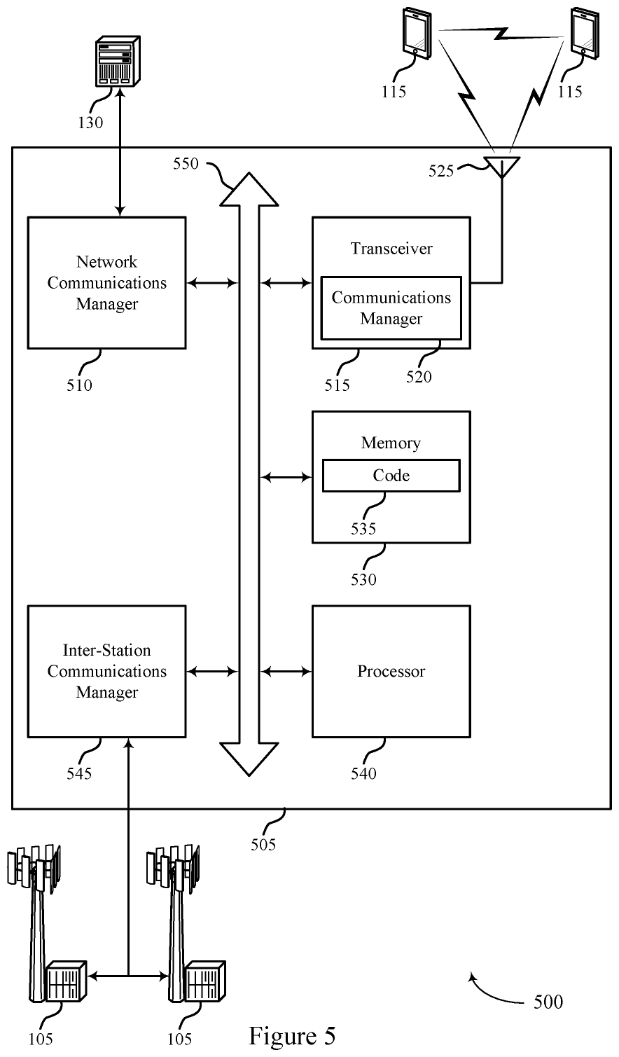

FIG. 5 shows a block diagram 500 of an example device 505 that supports applying a unified TCI state to a downlink reference signal. The device 505 may communicate wirelessly with one or more base stations 105, UEs 115, or any combination thereof. The device 505 may include components for bi-directional voice and data communications including components for transmitting and receiving communications, such as a communications manager 520, a network communications manager 510, a transceiver 515, an antenna 525, a memory 530, code 535, a processor 540, and an inter-station communications manager 545. These components may be in electronic communication or otherwise coupled (such as operatively, communicatively, functionally, electronically, electrically) via one or more buses (such as a bus 550).

The network communications manager 510 may manage communications with a core network 130 (for example, via one or more wired backhaul links). For example, the network communications manager 510 may manage the transfer of data communications for client devices, such as one or more UEs 115.

In some implementations, the device 505 may include a single antenna 525. However, in some other implementations, the device 505 may have more than one antenna 525, which may be capable of concurrently transmitting or receiving multiple wireless transmissions. The transceiver 515 may communicate bi-directionally, via the one or more antennas 525, wired, or wireless links as described herein. For example, the transceiver 515 may represent a wireless transceiver and may communicate bi-directionally with another wireless transceiver. The transceiver 515 also may include a modem to modulate the packets, to provide the modulated packets to one or more antennas 525 for transmission, and to demodulate packets received from the one or more antennas 525. In some implementations, the transceiver 515 may include one or more interfaces, such as one or more interfaces coupled with the one or more antennas 525 that are configured to support various receiving or obtaining operations, or one or more interfaces coupled with the one or more antennas 525 that are configured to support various transmitting or outputting operations, or a combination thereof. In some implementations, the transceiver 515 may include or be configured for coupling with one or more processors or memory components that are operable to perform or support operations based on or associated with received or obtained information or signals, or to generate information or other signals for transmission or other outputting, or any combination thereof. In some implementations, the transceiver 515, or the transceiver 515 and the one or more antennas 525, or the transceiver 515 and the one or more antennas 525 and one or more processors or memory components (for example, the processor 540, or the memory 530, or both), may be included in a chip or chip assembly that is installed in the device 505.

The memory 530 may include RAM and ROM. The memory 530 may store computer-readable, computer-executable code 535 including instructions that, when executed by the processor 540, cause the device 505 to perform various functions described herein. The code 535 may be stored in a non-transitory computer-readable medium such as system memory or another type of memory. In some implementations, the code 535 may not be directly executable by the processor 540 but may cause a computer (for example, when compiled and executed) to perform functions described herein. In some implementations, the memory 530 may contain, among other things, a BIOS which may control basic hardware or software operation such as the interaction with peripheral components or devices.

The processor 540 may be any one or more suitable processors capable of executing scripts or instructions of one or more software programs stored in the device 505 (such as within the memory 530). In some implementations, the processor 540 may be a component of a processing system. A processing system may generally refer to a system or series of machines or components that receives inputs and processes the inputs to produce a set of outputs (which may be passed to other systems or components of, for example, the device 505). For example, a processing system of the device 505 may refer to a system including the various other components or subcomponents of the device 505, such as the processor 540, or the transceiver 515, or the communications manager 520, or other components or combinations of components of the device 505. The processing system of the device 505 may interface with other components of the device 505, and may process information received from other components (such as inputs or signals) or output information to other components. For example, a chip or modem of the device 505 may include a processing system, a first interface to output information, and a second interface to obtain information. In some implementations, the first interface may refer to an interface between the processing system of the chip or modem and a transmitter, such that the device 505 may transmit information output from the chip or modem. In some implementations, the second interface may refer to an interface between the processing system of the chip or modem and a receiver, such that the device 505 may obtain information or signal inputs, and the information may be passed to the processing system. A person having ordinary skill in the art will readily recognize that the first interface also may obtain information or signal inputs, and the second interface also may output information or signal outputs.

The inter-station communications manager 545 may manage communications with other base stations 105, and may include a controller or scheduler for controlling communications with UEs 115 in cooperation with other base stations 105. For example, the inter-station communications manager 545 may coordinate scheduling for transmissions to UEs 115 for various interference mitigation techniques such as beamforming or joint transmission. In some implementations, the inter-station communications manager 545 may provide an X2 interface within an LTE/LTE-A wireless communications network technology to provide communication between base stations 105.

The communications manager 520 may support wireless communication at a network entity in accordance with examples as disclosed herein. For example, the communications manager 520 may be configured as or otherwise support a means for transmitting, to a UE, a first control signal indicating a unified TCI state, where the unified TCI state is associated with downlink data channel transmission and downlink control channel transmission. The communications manager 520 may be configured as or otherwise support a means for transmitting, to the UE, a downlink reference signal in accordance with the unified TCI state, and associated with satisfaction of a condition.

In some implementations, the communications manager 520 may be configured as or otherwise support a means for transmitting a second control signal indicating a repetition status of the downlink reference signal, where the repetition status satisfies the condition. In some implementations, the repetition status satisfies the condition by the repetition status indicating a lack of repetition for the downlink reference signal.

In some implementations, the communications manager 520 may be configured as or otherwise support a means for transmitting a second control signal indicating a triggering offset associated with the downlink reference signal, where the triggering offset satisfies the condition. In some implementations, the triggering offset satisfies the condition by the triggering offset being less than a time duration associated with a beam switching capability of the UE.

In some implementations, the communications manager 520 may be configured as or otherwise support a means for transmitting a second control signal indicating a type of the downlink reference signal, where the condition is satisfied based on or associated with the type of the downlink reference signal. In some implementations, the type of the downlink reference signal satisfies the condition by the type being a cell-specific reference signal. In some implementations, the type of the downlink reference signal satisfies the condition by the type being a periodic or semi-persistent reference signal that is for channel state information acquisition.

In some implementations, the condition is satisfied based on or associated with whether the downlink reference signal is associated with a configured TCI state. In some implementations, the downlink reference signal lacking an association with the configured TCI state satisfies the condition.

In some implementations, the communications manager 520 may be configured as or otherwise support a means for transmitting an indication of timing resources for at least one of a downlink data channel or a downlink control channel associated with the unified TCI state, where the condition is satisfied based on or associated with whether the downlink reference signal at least partially overlaps the timing resources. In some implementations, the downlink reference signal at least partially overlapping in time with at least one of the downlink data channel or the downlink control channel satisfies the condition.

In some implementations, the communications manager 520 may be configured as or otherwise support a means for receiving a channel state information report or a beam management report associated with the transmitting of the downlink reference signal, where the downlink reference signal includes a channel state information reference signal or a tracking reference signal.

In some implementations, the communications manager 520 may be configured to perform various operations (for example, receiving, monitoring, transmitting) using or otherwise in cooperation with the transceiver 515, the one or more antennas 525, or any combination thereof. Although the communications manager 520 is illustrated as a separate component, in some implementations, one or more functions described with reference to the communications manager 520 may be supported by or performed by the processor 540, the memory 530, the code 535, or any combination thereof. For example, the code 535 may include instructions executable by the processor 540 to cause the device 505 to perform various aspects of applying a unified TCI state to a downlink reference signal as described herein, or the processor 540 and the memory 530 may be otherwise configured to perform or support such operations.

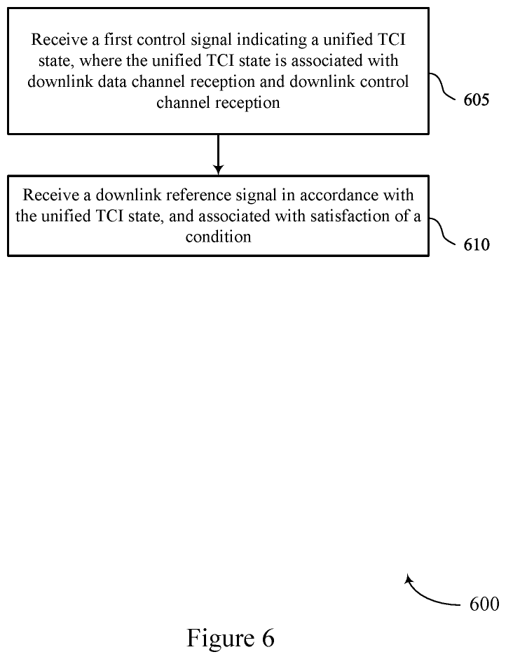

FIG. 6 shows a flowchart illustrating an example method 600 that supports applying a unified TCI state to a downlink reference signal. The operations of the method 600 may be implemented by a UE or its components as described herein. For example, the operations of the method 600 may be performed by a UE 115 as described with reference to FIGS. 1-4. In some implementations, a UE may execute a set of instructions to control the functional elements of the UE to perform the described functions. Additionally, or alternatively, the UE may perform aspects of the described functions using special-purpose hardware.

At 605, the method may include receiving a first control signal indicating a unified TCI state, where the unified TCI state is associated with downlink data channel reception and downlink control channel reception. The operations of 605 may be performed in accordance with examples as disclosed herein. In some implementations, aspects of the operations of 605 may be performed by a communications manager 420 as described with reference to FIG. 4.

At 610, the method may include receiving a downlink reference signal in accordance with the unified TCI state, and associated with satisfaction of a condition. The operations of 610 may be performed in accordance with examples as disclosed herein. In some implementations, aspects of the operations of 610 may be performed by a communications manager 420 as described with reference to FIG. 4.

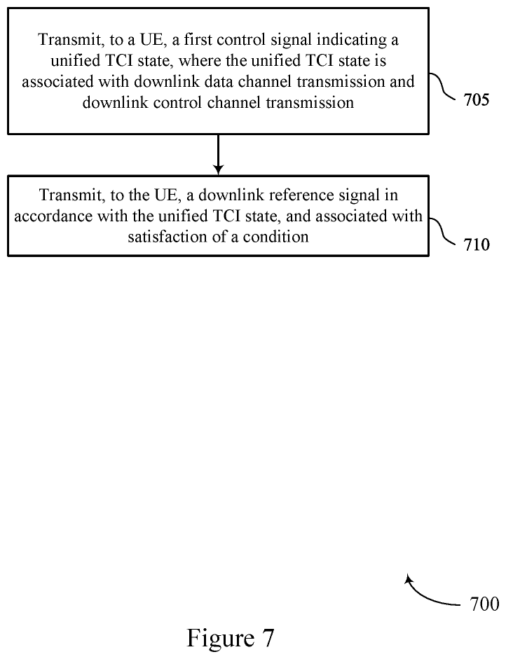

FIG. 7 shows a flowchart illustrating an example method 700 that supports applying a unified TCI state to a downlink reference signal. The operations of the method 700 may be implemented by a base station or its components as described herein. For example, the operations of the method 700 may be performed by a base station 105 as described with reference to FIGS. 1-3 and 5. In some implementations, a base station may execute a set of instructions to control the functional elements of the base station to perform the described functions. Additionally, or alternatively, the base station may perform aspects of the described functions using special-purpose hardware.

At 705, the method may include transmitting, to a UE, a first control signal indicating a unified TCI state, where the unified TCI state is associated with downlink data channel transmission and downlink control channel transmission. The operations of 705 may be performed in accordance with examples as disclosed herein. In some implementations, aspects of the operations of 705 may be performed by a communications manager 520 as described with reference to FIG. 5.

At 710, the method may include transmitting, to the UE, a downlink reference signal in accordance with the unified TCI state, and associated with satisfaction of a condition. The operations of 710 may be performed in accordance with examples as disclosed herein. In some implementations, aspects of the operations of 710 may be performed by a communications manager 520 as described with reference to FIG. 5.

The following provides an overview of some aspects of the present disclosure:

Aspect 1: An apparatus for wireless communication at a UE, including: a first interface configured to: obtain a first control signal indicating a unified TCI state, where the unified TCI state is associated with downlink data channel reception and downlink control channel reception; and obtain a downlink reference signal in accordance with the unified TCI state, and associated with satisfaction of a condition.

Aspect 2: The apparatus of aspect 1, where the first interface is further configured to: obtain a second control signal indicating a repetition status of the downlink reference signal, where the repetition status satisfies the condition.

Aspect 3: The apparatus of aspect 2, where the repetition status satisfies the condition by the repetition status indicating a lack of repetition for the downlink reference signal.

Aspect 4: The apparatus of any of aspects 1-3, where the first interface is further configured to: obtain a second control signal indicating a triggering offset associated with the downlink reference signal, where the triggering offset satisfies the condition.

Aspect 5: The apparatus of aspect 4, where the triggering offset satisfies the condition by the triggering offset being less than a time duration associated with a beam switching capability of the UE.

Aspect 6: The apparatus of any of aspects 1-5, where the first interface is further configured to: obtain a second control signal indicating a type of the downlink reference signal, where the condition is satisfied based on the type of the downlink reference signal.

Aspect 7: The apparatus of aspect 6, where the type of the downlink reference signal satisfies the condition by the type being a cell-specific reference signal.

Aspect 8: The apparatus of any of aspects 6-7, where the type of the downlink reference signal satisfies the condition by the type being a periodic or semi-persistent reference signal that is for CSI acquisition.

Aspect 9: The apparatus of any of aspects 1-8, where the condition is satisfied based on whether the downlink reference signal is associated with a configured TCI state.

Aspect 10: The apparatus of aspect 9, where the downlink reference signal lacking an association with the configured TCI state satisfies the condition.

Aspect 11: The apparatus of any of aspects 1-10, where the first interface is further configured to: obtain an indication of timing resources for at least one of a downlink data channel or a downlink control channel associated with the unified TCI state, where the condition is satisfied based on whether the downlink reference signal at least partially overlaps the timing resources.

Aspect 12: The apparatus of aspect 11, where the downlink reference signal at least partially overlapping in time with at least one of the downlink data channel or the downlink control channel satisfies the condition.

Aspect 13: The apparatus of any of aspects 1-12, where the first interface or a second interface is configured to: output a CSI report or a beam management report associated with the obtaining of the downlink reference signal, where the downlink reference signal includes a CSI-RS or a TRS.

Aspect 14: An apparatus for wireless communication at a network entity, including: a first interface configured to: output, to a UE, a first control signal indicating a unified TCI state, where the unified TCI state is associated with downlink data channel transmission and downlink control channel transmission: and output, to the UE, a downlink reference signal in accordance with the unified TCI state, and associated with satisfaction of a condition.

Aspect 15: The apparatus of aspect 14, where the first interface is further configured to: output a second control signal indicating a repetition status of the downlink reference signal, where the repetition status satisfies the condition.

Aspect 16: The apparatus of aspect 15, where the repetition status satisfies the condition by the repetition status indicating a lack of repetition for the downlink reference signal.

Aspect 17: The apparatus of any of aspects 14-16, where the first interface is further configured to: output a second control signal indicating a triggering offset associated with the downlink reference signal, where the triggering offset satisfies the condition.

Aspect 18: The apparatus of aspect 17, where the triggering offset satisfies the condition by the triggering offset being less than a time duration associated with a beam switching capability of the UE.

Aspect 19: The apparatus of any of aspects 14-18, where the first interface is further configured to: output a second control signal indicating a type of the downlink reference signal, where the condition is satisfied based on the type of the downlink reference signal.

Aspect 20: The apparatus of aspect 19, where the type of the downlink reference signal satisfies the condition by the type being a cell-specific reference signal.

Aspect 21: The apparatus of any of aspects 19-20, where the type of the downlink reference signal satisfies the condition by the type being a periodic or semi-persistent reference signal that is for CSI acquisition.

Aspect 22: The apparatus of any of aspects 14-21, where the condition is satisfied based on whether the downlink reference signal is associated with a configured TCI state.

Aspect 23: The apparatus of aspect 22, where the downlink reference signal lacking an association with the configured TCI state satisfies the condition.

Aspect 24: The apparatus of any of aspects 14-23, where the first interface is further configured to: output an indication of timing resources for at least one of a downlink data channel or a downlink control channel associated with the unified TCI state, where the condition is satisfied based on whether the downlink reference signal at least partially overlaps the timing resources.

Aspect 25: The apparatus of aspect 24, where the downlink reference signal at least partially overlapping in time with at least one of the downlink data channel or the downlink control channel satisfies the condition.

Aspect 26: The apparatus of any of aspects 14-25, where the first interface or a second interface is configured to: obtain a CSI report or a beam management report associated with the outputting of the downlink reference signal, where the downlink reference signal includes a CSI-RS or a TRS.

Aspect 27: A method for wireless communication at a UE, including: receiving a first control signal indicating a unified TCI state, where the unified TCI state is associated with downlink data channel reception and downlink control channel reception: and receiving a downlink reference signal in accordance with the unified TCI state, and associated with satisfaction of a condition.

Aspect 28: The method of aspect 27, further including: receiving a second control signal indicating a repetition status of the downlink reference signal, where the repetition status satisfies the condition.

Aspect 29: The method of aspect 28, where the repetition status satisfies the condition by the repetition status indicating a lack of repetition for the downlink reference signal.

Aspect 30: The method of any of aspects 27-29, further including: receiving a second control signal indicating a triggering offset associated with the downlink reference signal, where the triggering offset satisfies the condition.

Aspect 31: The method of aspect 30, where the triggering offset satisfies the condition by the triggering offset being less than a time duration associated with a beam switching capability of the UE.

Aspect 32: The method of any of aspects 27-31, further including: receiving a second control signal indicating a type of the downlink reference signal, where the condition is satisfied based on the type of the downlink reference signal.

Aspect 33: The method of aspect 32, where the type of the downlink reference signal satisfies the condition by the type being a cell-specific reference signal.

Aspect 34: The method of any of aspects 32-33, where the type of the downlink reference signal satisfies the condition by the type being a periodic or semi-persistent reference signal that is for CSI acquisition.

Aspect 35: The method of any of aspects 27-34, where the condition is satisfied based on whether the downlink reference signal is associated with a configured TCI state.

Aspect 36: The method of aspect 35, where the downlink reference signal lacking an association with the configured TCI state satisfies the condition.

Aspect 37: The method of any of aspects 27-36, further including: receiving an indication of timing resources for at least one of a downlink data channel or a downlink control channel associated with the unified TCI state, where the condition is satisfied based on whether the downlink reference signal at least partially overlaps the timing resources.

Aspect 38: The method of aspect 37, where the downlink reference signal at least partially overlapping in time with at least one of the downlink data channel or the downlink control channel satisfies the condition.

Aspect 39: The method of any of aspects 27-38, further including: transmitting a CSI report or a beam management report associated with the receiving of the downlink reference signal, where the downlink reference signal includes a CSI-RS or a TRS.

Aspect 40: A method for wireless communication at a network entity, including: transmitting, to a UE, a first control signal indicating a unified TCI state, where the unified TCI state is associated with downlink data channel transmission and downlink control channel transmission; and transmitting, to the UE, a downlink reference signal in accordance with the unified TCI state, and associated with satisfaction of a condition.

Aspect 41: The method of aspect 40, further including: transmitting a second control signal indicating a repetition status of the downlink reference signal, where the repetition status satisfies the condition.

Aspect 42: The method of aspect 41, where the repetition status satisfies the condition by the repetition status indicating a lack of repetition for the downlink reference signal.

Aspect 43: The method of any of aspects 40-42, further including: transmitting a second control signal indicating a triggering offset associated with the downlink reference signal, where the triggering offset satisfies the condition.

Aspect 44: The method of aspect 43, where the triggering offset satisfies the condition by the triggering offset being less than a time duration associated with a beam switching capability of the UE.

Aspect 45: The method of any of aspects 40-44, further including: transmitting a second control signal indicating a type of the downlink reference signal, where the condition is satisfied based on the type of the downlink reference signal.

Aspect 46: The method of aspect 45, where the type of the downlink reference signal satisfies the condition by the type being a cell-specific reference signal.

Aspect 47: The method of any of aspects 45-46, where the type of the downlink reference signal satisfies the condition by the type being a periodic or semi-persistent reference signal that is for CSI acquisition.

Aspect 48: The method of any of aspects 40-47, where the condition is satisfied based on whether the downlink reference signal is associated with a configured TCI state.

Aspect 49: The method of aspect 48, where the downlink reference signal lacking an association with the configured TCI state satisfies the condition.

Aspect 50: The method of any of aspects 40-49, further including: transmitting an indication of timing resources for at least one of a downlink data channel or a downlink control channel associated with the unified TCI state, where the condition is satisfied based on whether the downlink reference signal at least partially overlaps the timing resources.

Aspect 51: The method of aspect 50, where the downlink reference signal at least partially overlapping in time with at least one of the downlink data channel or the downlink control channel satisfies the condition.

Aspect 52: The method of any of aspects 40-51, further including: receiving a CSI report or a beam management report associated with the transmitting of the downlink reference signal, where the downlink reference signal includes a CSI-RS or a TRS.

Aspect 53: An apparatus for wireless communication at a UE, including: a processor: memory coupled with the processor; and instructions stored in the memory and executable by the processor to cause the apparatus to: receive a first control signal indicating a unified TCI state, where the unified TCI state is associated with downlink data channel reception and downlink control channel reception; and receive a downlink reference signal in accordance with the unified TCI state, and associated with satisfaction of a condition.

Aspect 54: The apparatus of aspect 53, where the instructions are further executable by the processor to cause the apparatus to: receive a second control signal indicating a repetition status of the downlink reference signal, where the repetition status satisfies the condition.

Aspect 55: The apparatus of aspect 54, where the repetition status satisfies the condition by the repetition status indicating a lack of repetition for the downlink reference signal.

Aspect 56: The apparatus of any of aspects 53-55, where the instructions are further executable by the processor to cause the apparatus to: receive a second control signal indicating a triggering offset associated with the downlink reference signal, where the triggering offset satisfies the condition.

Aspect 57: The apparatus of aspect 56, where the triggering offset satisfies the condition by the triggering offset being less than a time duration associated with a beam switching capability of the UE.

Aspect 58: The apparatus of any of aspects 53-57, where the instructions are further executable by the processor to cause the apparatus to: receive a second control signal indicating a type of the downlink reference signal, where the condition is satisfied based on the type of the downlink reference signal.

Aspect 59: The apparatus of aspect 58, where the type of the downlink reference signal satisfies the condition by the type being a cell-specific reference signal.

Aspect 60: The apparatus of any of aspects 58-59, where the type of the downlink reference signal satisfies the condition by the type being a periodic or semi-persistent reference signal that is for CSI acquisition.

Aspect 61: The apparatus of any of aspects 53-60, where the condition is satisfied based on whether the downlink reference signal is associated with a configured TCI state.

Aspect 62: The apparatus of aspect 61, where the downlink reference signal lacking an association with the configured TCI state satisfies the condition.

Aspect 63: The apparatus of any of aspects 53-62, where the instructions are further executable by the processor to cause the apparatus to: receive an indication of timing resources for at least one of a downlink data channel or a downlink control channel associated with the unified TCI state, where the condition is satisfied based on whether the downlink reference signal at least partially overlaps the timing resources.

Aspect 64: The apparatus of aspect 63, where the downlink reference signal at least partially overlapping in time with at least one of the downlink data channel or the downlink control channel satisfies the condition.

Aspect 65: The apparatus of any of aspects 53-64, where the instructions are further executable by the processor to cause the apparatus to: transmit a CSI report or a beam management report associated with the receiving of the downlink reference signal, where the downlink reference signal includes a CSI-RS or a TRS.

Aspect 66: An apparatus for wireless communication at a network entity, including: a processor: memory coupled with the processor: and instructions stored in the memory and executable by the processor to cause the apparatus to: transmit, to a UE, a first control signal indicating a unified TCI state, where the unified TCI state is associated with downlink data channel transmission and downlink control channel transmission: and transmit, to the UE, a downlink reference signal in accordance with the unified TCI state, and associated with satisfaction of a condition.

Aspect 67: The apparatus of aspect 66, where the instructions are further executable by the processor to cause the apparatus to: transmit a second control signal indicating a repetition status of the downlink reference signal, where the repetition status satisfies the condition.

Aspect 68: The apparatus of aspect 67, where the repetition status satisfies the condition by the repetition status indicating a lack of repetition for the downlink reference signal.

Aspect 69: The apparatus of any of aspects 66-68, where the instructions are further executable by the processor to cause the apparatus to: transmit a second control signal indicating a triggering offset associated with the downlink reference signal, where the triggering offset satisfies the condition.

Aspect 70: The apparatus of aspect 69, where the triggering offset satisfies the condition by the triggering offset being less than a time duration associated with a beam switching capability of the UE.

Aspect 71: The apparatus of any of aspects 66-70, where the instructions are further executable by the processor to cause the apparatus to: transmit a second control signal indicating a type of the downlink reference signal, where the condition is satisfied based on the type of the downlink reference signal.

Aspect 72: The apparatus of aspect 71, where the type of the downlink reference signal satisfies the condition by the type being a cell-specific reference signal.

Aspect 73: The apparatus of any of aspects 71-72, where the type of the downlink reference signal satisfies the condition by the type being a periodic or semi-persistent reference signal that is for CSI acquisition.

Aspect 74: The apparatus of any of aspects 66-73, where the condition is satisfied based on whether the downlink reference signal is associated with a configured TCI state.

Aspect 75: The apparatus of aspect 74, where the downlink reference signal lacking an association with the configured TCI state satisfies the condition.

Aspect 76: The apparatus of any of aspects 66-75, where the instructions are further executable by the processor to cause the apparatus to: transmit an indication of timing resources for at least one of a downlink data channel or a downlink control channel associated with the unified TCI state, where the condition is satisfied based on whether the downlink reference signal at least partially overlaps the timing resources.

Aspect 77: The apparatus of aspect 76, where the downlink reference signal at least partially overlapping in time with at least one of the downlink data channel or the downlink control channel satisfies the condition.

Aspect 78: The apparatus of any of aspects 66-77, where the instructions are further executable by the processor to cause the apparatus to: receive a CSI report or a beam management report associated with the transmitting of the downlink reference signal, where the downlink reference signal includes a CSI-RS or a TRS.

Aspect 79: An apparatus for wireless communication at a UE, including: means for receiving a first control signal indicating a unified TCI state, where the unified TCI state is associated with downlink data channel reception and downlink control channel reception; and means for receiving a downlink reference signal in accordance with the unified TCI state, and associated with satisfaction of a condition.

Aspect 80: The apparatus of aspect 79, further including: means for receiving a second control signal indicating a repetition status of the downlink reference signal, where the repetition status satisfies the condition.

Aspect 81: The apparatus of aspect 80, where the repetition status satisfies the condition by the repetition status indicating a lack of repetition for the downlink reference signal.

Aspect 82: The apparatus of any of aspects 79-81, further including: means for receiving a second control signal indicating a triggering offset associated with the downlink reference signal, where the triggering offset satisfies the condition.

Aspect 83: The apparatus of aspect 82, where the triggering offset satisfies the condition by the triggering offset being less than a time duration associated with a beam switching capability of the UE.

Aspect 84: The apparatus of any of aspects 79-83, further including: means for receiving a second control signal indicating a type of the downlink reference signal, where the condition is satisfied based on the type of the downlink reference signal.

Aspect 85: The apparatus of aspect 84, where the type of the downlink reference signal satisfies the condition by the type being a cell-specific reference signal.

Aspect 86: The apparatus of any of aspects 84-85, where the type of the downlink reference signal satisfies the condition by the type being a periodic or semi-persistent reference signal that is for CSI acquisition.

Aspect 87: The apparatus of any of aspects 79-86, where the condition is satisfied based on whether the downlink reference signal is associated with a configured TCI state.

Aspect 88: The apparatus of aspect 87, where the downlink reference signal lacking an association with the configured TCI state satisfies the condition.

Aspect 89: The apparatus of any of aspects 79-88, further including: means for receiving an indication of timing resources for at least one of a downlink data channel or a downlink control channel associated with the unified TCI state, where the condition is satisfied based on whether the downlink reference signal at least partially overlaps the timing resources.

Aspect 90: The apparatus of aspect 89, where the downlink reference signal at least partially overlapping in time with at least one of the downlink data channel or the downlink control channel satisfies the condition.

Aspect 91: The apparatus of any of aspects 79-90, further including: means for transmitting a CSI report or a beam management report associated with the receiving of the downlink reference signal, where the downlink reference signal includes a CSI-RS or a TRS.

Aspect 92: An apparatus for wireless communication at a network entity, including: means for transmitting, to a UE, a first control signal indicating a unified TCI state, where the unified TCI state is associated with downlink data channel transmission and downlink control channel transmission; and means for transmitting, to the UE, a downlink reference signal in accordance with the unified TCI state, and associated with satisfaction of a condition.

Aspect 93: The apparatus of aspect 92, further including: means for transmitting a second control signal indicating a repetition status of the downlink reference signal, where the repetition status satisfies the condition.

Aspect 94: The apparatus of aspect 93, where the repetition status satisfies the condition by the repetition status indicating a lack of repetition for the downlink reference signal.

Aspect 95: The apparatus of any of aspects 92-94, further including: means for transmitting a second control signal indicating a triggering offset associated with the downlink reference signal, where the triggering offset satisfies the condition.

Aspect 96: The apparatus of aspect 95, where the triggering offset satisfies the condition by the triggering offset being less than a time duration associated with a beam switching capability of the UE.

Aspect 97: The apparatus of any of aspects 92-96, further including: means for transmitting a second control signal indicating a type of the downlink reference signal, where the condition is satisfied based on the type of the downlink reference signal.

Aspect 98: The apparatus of aspect 97, where the type of the downlink reference signal satisfies the condition by the type being a cell-specific reference signal.

Aspect 99: The apparatus of any of aspects 97-98, where the type of the downlink reference signal satisfies the condition by the type being a periodic or semi-persistent reference signal that is for CSI acquisition.

Aspect 100: The apparatus of any of aspects 92-99, where the condition is satisfied based on whether the downlink reference signal is associated with a configured TCI state.

Aspect 101: The apparatus of aspect 100, where the downlink reference signal lacking an association with the configured TCI state satisfies the condition.

Aspect 102: The apparatus of any of aspects 92-101, further including: means for transmitting an indication of timing resources for at least one of a downlink data channel or a downlink control channel associated with the unified TCI state, where the condition is satisfied based on whether the downlink reference signal at least partially overlaps the timing resources.

Aspect 103: The apparatus of aspect 102, where the downlink reference signal at least partially overlapping in time with at least one of the downlink data channel or the downlink control channel satisfies the condition.

Aspect 104: The apparatus of any of aspects 92-103, further including: means for receiving a CSI report or a beam management report associated with the transmitting of the downlink reference signal, where the downlink reference signal includes a CSI-RS or a TRS.

Aspect 105: A non-transitory computer-readable medium storing code for wireless communication at a UE, the code including instructions executable by a processor to: receive a first control signal indicating a unified TCI state, where the unified TCI state is associated with downlink data channel reception and downlink control channel reception; and receive a downlink reference signal in accordance with the unified TCI state, and associated with satisfaction of a condition.

Aspect 106: The non-transitory computer-readable medium of aspect 105, where the instructions are further executable by the processor to: receive a second control signal indicating a repetition status of the downlink reference signal, where the repetition status satisfies the condition.

Aspect 107: The non-transitory computer-readable medium of aspect 106, where the repetition status satisfies the condition by the repetition status indicating a lack of repetition for the downlink reference signal.

Aspect 108: The non-transitory computer-readable medium of any of aspects 105-107, where the instructions are further executable by the processor to: receive a second control signal indicating a triggering offset associated with the downlink reference signal, where the triggering offset satisfies the condition.

Aspect 109: The non-transitory computer-readable medium of aspect 108, where the triggering offset satisfies the condition by the triggering offset being less than a time duration associated with a beam switching capability of the UE.

Aspect 110: The non-transitory computer-readable medium of any of aspects 105-109, where the instructions are further executable by the processor to: receive a second control signal indicating a type of the downlink reference signal, where the condition is satisfied based on the type of the downlink reference signal.

Aspect 111: The non-transitory computer-readable medium of aspect 110, where the type of the downlink reference signal satisfies the condition by the type being a cell-specific reference signal.

Aspect 112: The non-transitory computer-readable medium of any of aspects 110-111, where the type of the downlink reference signal satisfies the condition by the type being a periodic or semi-persistent reference signal that is for CSI acquisition.

Aspect 113: The non-transitory computer-readable medium of any of aspects 105-112, where the condition is satisfied based on whether the downlink reference signal is associated with a configured TCI state.

Aspect 114: The non-transitory computer-readable medium of aspect 113, where the downlink reference signal lacking an association with the configured TCI state satisfies the condition.

Aspect 115: The non-transitory computer-readable medium of any of aspects 105-114, where the instructions are further executable by the processor to: receive an indication of timing resources for at least one of a downlink data channel or a downlink control channel associated with the unified TCI state, where the condition is satisfied based on whether the downlink reference signal at least partially overlaps the timing resources.

Aspect 116: The non-transitory computer-readable medium of aspect 115, where the downlink reference signal at least partially overlapping in time with at least one of the downlink data channel or the downlink control channel satisfies the condition.

Aspect 117: The non-transitory computer-readable medium of any of aspects 105-116, where the instructions are further executable by the processor to: transmit a CSI report or a beam management report associated with the receiving of the downlink reference signal, where the downlink reference signal includes a CSI-RS or a TRS.

Aspect 118: A non-transitory computer-readable medium storing code for wireless communication at a network entity, the code including instructions executable by a processor to: transmit, to a UE, a first control signal indicating a unified TCI state, where the unified TCI state is associated with downlink data channel transmission and downlink control channel transmission; and transmit, to the UE, a downlink reference signal in accordance with the unified TCI state, and associated with satisfaction of a condition.

Aspect 119: The non-transitory computer-readable medium of aspect 118, where the instructions are further executable by the processor to: transmit a second control signal indicating a repetition status of the downlink reference signal, where the repetition status satisfies the condition.

Aspect 120: The non-transitory computer-readable medium of aspect 119, where the repetition status satisfies the condition by the repetition status indicating a lack of repetition for the downlink reference signal.

Aspect 121: The non-transitory computer-readable medium of any of aspects 118-120, where the instructions are further executable by the processor to: transmit a second control signal indicating a triggering offset associated with the downlink reference signal, where the triggering offset satisfies the condition.

Aspect 122: The non-transitory computer-readable medium of aspect 121, where the triggering offset satisfies the condition by the triggering offset being less than a time duration associated with a beam switching capability of the UE.

Aspect 123: The non-transitory computer-readable medium of any of aspects 118-122, where the instructions are further executable by the processor to: transmit a second control signal indicating a type of the downlink reference signal, where the condition is satisfied based on the type of the downlink reference signal.

Aspect 124: The non-transitory computer-readable medium of aspect 123, where the type of the downlink reference signal satisfies the condition by the type being a cell-specific reference signal.

Aspect 125: The non-transitory computer-readable medium of any of aspects 123-124, where the type of the downlink reference signal satisfies the condition by the type being a periodic or semi-persistent reference signal that is for CSI acquisition.

Aspect 126: The non-transitory computer-readable medium of any of aspects 118-125, where the condition is satisfied based on whether the downlink reference signal is associated with a configured TCI state.

Aspect 127: The non-transitory computer-readable medium of aspect 126, where the downlink reference signal lacking an association with the configured TCI state satisfies the condition.

Aspect 128: The non-transitory computer-readable medium of any of aspects 118-127, where the instructions are further executable by the processor to: transmit an indication of timing resources for at least one of a downlink data channel or a downlink control channel associated with the unified TCI state, where the condition is satisfied based on whether the downlink reference signal at least partially overlaps the timing resources.

Aspect 129: The non-transitory computer-readable medium of aspect 128, where the downlink reference signal at least partially overlapping in time with at least one of the downlink data channel or the downlink control channel satisfies the condition.

Aspect 130: The non-transitory computer-readable medium of any of aspects 118-129, where the instructions are further executable by the processor to: receive a CSI report or a beam management report associated with the transmitting of the downlink reference signal, where the downlink reference signal includes a CSI-RS or a TRS.

As used herein, the term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described herein as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described herein should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. An apparatus for wireless communication at a user equipment (UE), comprising:
a first interface configured to:
obtain a first control signal indicating a unified transmission configuration indicator (TCI) state, wherein the unified TCI state is associated with downlink data channel reception and downlink control channel reception; and
obtain a downlink reference signal in accordance with the unified TCI state, and associated with satisfaction of a condition.

2. The apparatus of claim 1, wherein the first interface is further configured to:
obtain a second control signal indicating a repetition status of the downlink reference signal, wherein the repetition status satisfies the condition.

3. The apparatus of claim 2, wherein the repetition status satisfies the condition by the repetition status indicating a lack of repetition for the downlink reference signal.

4. The apparatus of claim 1, wherein the first interface is further configured to:
obtain a second control signal indicating a triggering offset associated with the downlink reference signal, wherein the triggering offset satisfies the condition.

5. The apparatus of claim 4, wherein the triggering offset satisfies the condition by the triggering offset being less than a time duration associated with a beam switching capability of the UE.

6. The apparatus of claim 1, wherein the first interface is further configured to:
obtain a second control signal indicating a type of the downlink reference signal, wherein the condition is satisfied based at least in part on the type of the downlink reference signal.

7. The apparatus of claim 6, wherein the type of the downlink reference signal satisfies the condition by the type being a cell-specific reference signal.

8. The apparatus of claim 6, wherein the type of the downlink reference signal satisfies the condition by the type being a periodic or semi-persistent reference signal that is for channel state information acquisition.

9. The apparatus of claim 1, wherein the condition is satisfied based at least in part on whether the downlink reference signal is associated with a configured TCI state.

10. The apparatus of claim 9, wherein the downlink reference signal lacking an association with the configured TCI state satisfies the condition.

11. The apparatus of claim 1, wherein the first interface is further configured to:
obtain an indication of timing resources for at least one of a downlink data channel or a downlink control channel associated with the unified TCI state, wherein the condition is satisfied based at least in part on whether the downlink reference signal at least partially overlaps the timing resources.

12. The apparatus of claim 11, wherein the downlink reference signal at least partially overlapping in time with at least one of the downlink data channel or the downlink control channel satisfies the condition.

13. An apparatus for wireless communication at a network entity, comprising:
a first interface configured to:
output, to a user equipment (UE), a first control signal indicating a unified transmission configuration indicator (TCI) state, wherein the unified TCI state is associated with downlink data channel transmission and downlink control channel transmission; and
output, to the UE, a downlink reference signal in accordance with the unified TCI state, and associated with satisfaction of a condition.

14. The apparatus of claim 13, wherein the first interface is further configured to:
output a second control signal indicating a repetition status of the downlink reference signal, wherein the repetition status satisfies the condition.

15. The apparatus of claim 14, wherein the repetition status satisfies the condition by the repetition status indicating a lack of repetition for the downlink reference signal.

16. The apparatus of claim 13, wherein the first interface is further configured to:
output a second control signal indicating a triggering offset associated with the downlink reference signal, wherein the triggering offset satisfies the condition.

17. The apparatus of claim 16, wherein the triggering offset satisfies the condition by the triggering offset being less than a time duration associated with a beam switching capability of the UE.

18. The apparatus of claim 13, wherein the first interface is further configured to:
output a second control signal indicating a type of the downlink reference signal, wherein the condition is satisfied based at least in part on the type of the downlink reference signal.

19. The apparatus of claim 18, wherein the type of the downlink reference signal satisfies the condition by the type being a cell-specific reference signal.

20. The apparatus of claim 18, wherein the type of the downlink reference signal satisfies the condition by the type being a periodic or semi-persistent reference signal that is for channel state information acquisition.

21. The apparatus of claim 13, wherein the condition is satisfied based at least in part on whether the downlink reference signal is associated with a configured TCI state.

22. The apparatus of claim 21, wherein the downlink reference signal lacking an association with the configured TCI state satisfies the condition.

23. The apparatus of claim 13, wherein the first interface is further configured to:
output an indication of timing resources for at least one of a downlink data channel or a downlink control channel associated with the unified TCI state, wherein the condition is satisfied based at least in part on whether the downlink reference signal at least partially overlaps the timing resources.

24. The apparatus of claim 23, wherein the downlink reference signal at least partially overlapping in time with at least one of the downlink data channel or the downlink control channel satisfies the condition.

25. A method for wireless communication at a user equipment (UE), comprising:
receiving a first control signal indicating a unified transmission configuration indicator (TCI) state, wherein the unified TCI state is associated with downlink data channel reception and downlink control channel reception; and
receiving a downlink reference signal in accordance with the unified TCI state, and associated with satisfaction of a condition.

26. The method of claim 25, further comprising:
receiving a second control signal indicating a repetition status of the downlink reference signal, wherein the repetition status satisfies the condition.

27. The method of claim 25, further comprising:
receiving a second control signal indicating a triggering offset associated with the downlink reference signal, wherein the triggering offset satisfies the condition.

28. A method for wireless communication at a network entity, comprising:
transmitting, to a user equipment (UE), a first control signal indicating a unified transmission configuration indicator (TCI) state, wherein the unified TCI state is associated with downlink data channel transmission and downlink control channel transmission; and
transmitting, to the UE, a downlink reference signal in accordance with the unified TCI state, and associated with satisfaction of a condition.

29. The method of claim 28, further comprising:
transmitting a second control signal indicating a repetition status of the downlink reference signal, wherein the repetition status satisfies the condition.

30. The method of claim 28, further comprising:
transmitting a second control signal indicating a triggering offset associated with the downlink reference signal, wherein the triggering offset satisfies the condition.
